(19) United States
(12) Patent Application Publication
(10) Pub. No.: US 2017/0299206 A1
(43) Pub. Date: Oct. 19, 2017

(54) REFRIGERANT PIPE AND HEAT PUMP APPARATUS

(71) Applicant: Mitsubishi Electric Corporation, Chiyoda-ku, Tokyo (JP)

(72) Inventors: Hajime IKEDA, Tokyo (JP); Takashi KOBAYASHI, Tokyo (JP); Shin KAWABE, Tokyo (JP); Yosuke KIKUCHI, Tokyo (JP); Fuminori KOBAYASHI, Tokyo (JP)

(73) Assignee: Mitsubishi Electric Corporation, Chiyoda-ku, Tokyo (JP)

(21) Appl. No.: 15/517,097

(22) PCT Filed: Oct. 8, 2014
(86) PCT No.: PCT/JP2014/076955

§ 371 Date: Apr. 5, 2017

(51) Int. Cl. F24F 3/08; F24F 3/00; F25B 29/00; G05D 23/00; F28B 1/00

(52) U.S. Cl. CPC F24F 3/08; F25B 29/003; F25B 29/00; F24F 3/00; F28B 1/00; G05D 23/00

(57) ABSTRACT

An object of the present invention is to allow uniform distribution of a refrigerant by a distributor. A refrigerant pipe includes a bent pipe formed in the shape of a curve and a downstream pipe connected to the downstream side of the bent pipe and formed to be linear. A distributor to distribute the refrigerant into a plurality of flow paths is connected to the downstream pipe on the downstream side. An inner wall on the inner peripheral side of the bent pipe being on the side of the curvature center of the curve is a grooved surface with a groove formed therein, and an inner wall on the outer peripheral side of the bent pipe being on the side opposite to the curvature center of the curve is a smooth surface.

### TECHNICAL FIELD

The present invention relates to a refrigerant pipe used for a heat pump apparatus such as an air conditioner, and the heat pump apparatus including the refrigerant pipe.

### BACKGROUND ART

A heat exchanger included in an outdoor unit of an air conditioner performs heat exchange between a refrigerant and outside air. This heat exchanger has a structure in which the refrigerant is distributed into a plurality of flow paths to be flown in order to enhance heat exchange efficiency. Therefore, a distributor is provided at the entrance of this heat exchanger to distribute the refrigerant into the plurality of flow paths. It is necessary to uniformly distribute the refrigerant into each flow path in order to enhance the heat exchange efficiency.

When this heat exchanger operates as an evaporator, the refrigerant to be flown into the heat exchanger is in a gas-liquid two-phase state. In this case, the refrigerant flows within the refrigerant pipe as an annular flow. That is, the refrigerant in a liquid phase flows as a liquid film along the inner wall of the refrigerant pipe, and the refrigerant in a gas phase flows inside the liquid film.

The shape of the liquid film is determined by gravity, inertial force, and surface tension. Therefore, in a curved portion of the refrigerant pipe, the liquid film becomes biased to the outer peripheral side of the curve by the inertial force, so that a drift of the refrigerant occurs. When the refrigerant flows into the distributor in a state where the drift occurs, the refrigerant is not uniformly distributed into each flow path.

Patent Literatures 1 and 2 each describe that a refrigerant pipe immediately before a distributor is inclined and grooves are provided in a lower inner wall of this refrigerant pipe in order to uniformly distribute a refrigerant in a gas-liquid two-phase state into two flow paths. In Patent Literature 1, a liquid refrigerant is uniformly distributed into a lower side of the pipe by gravity and surface tension of the portion where the grooves are formed.

### CITATION LIST

### Patent Literature

Patent Literature 1: JP 2003-90645A

Patent Literature 2: JP 2004-116809A

### Non-Patent Literature

Non-Patent Literature 1: Akio Isozaki, Mamoru Ishikawa, and Chikara Saeki, “Inner Grooved Copper Tubes Development”, Kobe Steel Engineering Reports, Vol. 50, No. 3 (December 2000)

### SUMMARY OF INVENTION

### Technical Problem

In order to uniformly distribute the liquid refrigerant using the gravity and the surface tension caused by the grooves, the refrigerant pipe that is linear and long must be provided, the refrigerant pipe must be inclined, and the grooves must be provided on a lower side of the refrigerant pipe. However, in an outdoor unit of an air conditioner, for example, a mounting space of components is limited, and it is necessary to shorten the refrigerant pipe that does not contribute to heat exchange as much as possible. Therefore, it is difficult to dispose the long and linear refrigerant pipe before the distributor.

An object of the present invention is to allow a refrigerant to be uniformly distributed by a distributor.

### Solution to Problem

A refrigerant pipe according to the present invention may include:

a bent pipe formed to be bent in a shape of a curve and to flow a refrigerant, wherein an inner wall on an inner peripheral side of the bent pipe being on a side of a curvature center of the curve is a grooved surface with a groove formed therein, and an inner wall on an outer peripheral side of the bent pipe being on a side opposite to the curvature center of the curve is a smooth surface; and

a downstream pipe connected to a downstream side of the bent pipe, formed to be linear, and with a distributor connected thereto on the downstream side, the distributor being to distribute the refrigerant into a plurality of flow paths.

### Advantageous Effects of Invention

In the present invention, the inner wall on the inner peripheral side of the bent pipe has been set to the grooved surface, and the inner wall on the outer peripheral side of the bent pipe has been set to the smooth surface. The refrigerant in a liquid phase becomes biased to the outer peripheral side of a curved portion due to inertial force. However, in the present invention, the liquid refrigerant is drawn to the inner peripheral side due to surface tension of the grooved surface. Thus, it may be restrained that the liquid refrigerant becomes biased to the outer peripheral side in the curved portion. With this arrangement, the biasing of the refrigerant that has passed through the bent pipe may be reduced. Thus, the refrigerant may be uniformly distributed by the distributor.

### BRIEF DESCRIPTION OF DRAWINGS

FIG. 1 is a diagram illustrating a refrigerant circuit 11 of a heat pump apparatus 10.

FIG. 2 is a diagram illustrating a fin 17 and refrigerant flow paths 18 constituting a heat exchanger 13.

FIG. 3 is an explanatory diagram of a refrigerant flowing in a refrigerant pipe 20 on the entrance side of an evaporator.

FIG. 4 is an explanatory diagram of the refrigerant flowing in a curved portion where the refrigerant pipe 20 has been bent.

FIG. 5 is a diagram illustrating the refrigerant pipe 20 according to a first embodiment.

FIG. 6 is a sectional view of the refrigerant pipe 20 according to the first embodiment.

FIG. 7 includes diagrams illustrating states of a liquid film 21 in the refrigerant pipe 20 illustrated in FIG. 5.

FIG. 8 is a diagram illustrating the refrigerant pipe 20 in which the entire inner wall of a downstream pipe 24 is set to a grooved surface 28, and the entire inner walls of other pipes 22 and 23 are set to a smooth surface 29.

FIG. 9 includes diagrams illustrating states of the liquid film 21 in the refrigerant pipe 20 given in FIG. 8.

FIG. 10 is a diagram illustrating a different configuration of the refrigerant pipe 20 according to the first embodiment.

FIG. 11 is a diagram illustrating a different configuration of the refrigerant pipe 20 according to the first embodiment.

FIG. 12 is a diagram illustrating a different configuration of the refrigerant pipe 20 according to the first embodiment.

FIG. 13 is a diagram illustrating the refrigerant pipe 20 bent from a horizontal direction to a downward direction.

FIG. 14 is a diagram illustrating the refrigerant pipe 20 bent from a downward direction to an upward direction.

FIG. 15 is a diagram illustrating a distributor 25.

FIG. 16 is a diagram illustrating a different configuration of the distributor 25.

FIG. 17 is a diagram illustrating the refrigerant pipe 20 when a groove 27 has been formed by crushing.

FIG. 18 is an explanatory diagram of the groove 27 illustrated in FIG. 17.

FIG. 19 is a diagram illustrating a different configuration of the refrigerant pipe 20 where the groove 27 has been formed by crushing.

### DESCRIPTION OF EMBODIMENTS

### First Embodiment

***Description of Configuration***

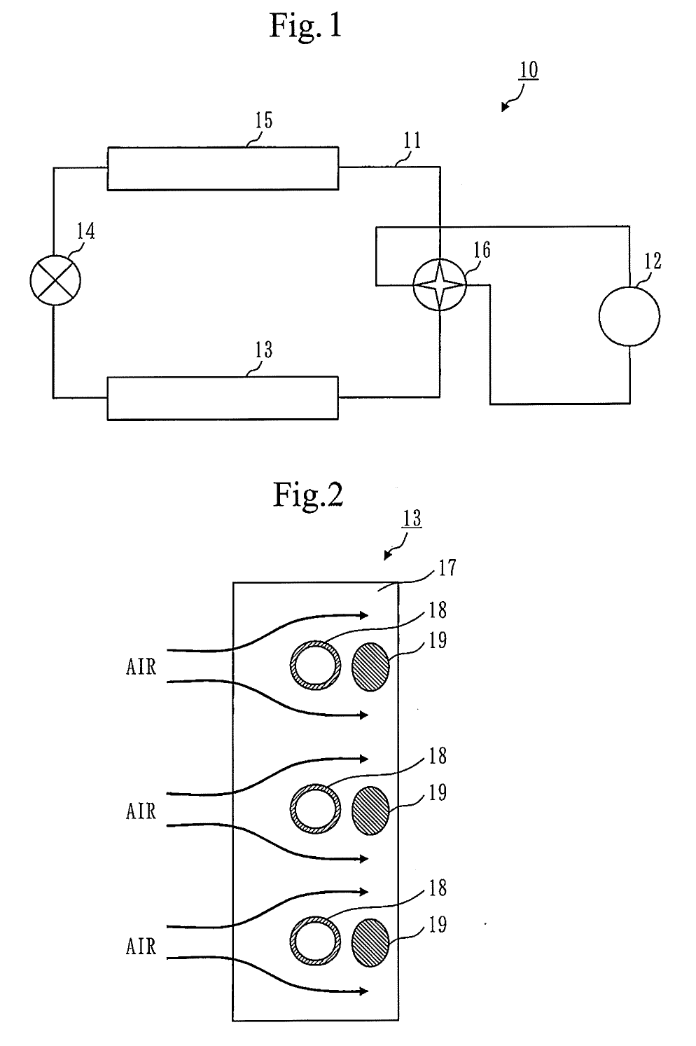

FIG. 1 is a diagram illustrating a refrigerant circuit 11 of a heat pump apparatus 10.

The heat pump apparatus 10 includes a compressor 12 to compress a refrigerant, a heat exchanger 13 to perform heat exchange between the refrigerant and air or the like, an expansion mechanism 14 to expand the refrigerant, a heat exchanger 15 to perform heat exchange between the refrigerant and air or the like, and a four-way valve 16 to switch a flowing direction of the refrigerant. The compressor 12, the heat exchanger 13, the expansion mechanism 14, and the heat exchanger 15 are sequentially connected by a refrigerant pipe, thereby forming the refrigerant circuit 11. The four-way valve 16 is connected to the discharge side of the compressor 12 in the refrigerant circuit 11.

FIG. 2 is a diagram illustrating a fin 17 and refrigerant flow paths 18 constituting the heat exchanger 13.

In the heat exchanger 13, the fin 17 is installed in the refrigerant flow paths 18. By generating an air flow by a fan or the like, the heat exchange between the refrigerant flowing in each refrigerant flow path 18 and the air is efficiently performed via the fin 17.

A dead region 19, in which no air flows and the heat exchange is scarcely performed, is herein formed at the backside of each refrigerant flow path 18. If the refrigerant flow path 18 is thinned, the dead region 19 may be reduced, so that a heat exchange area may be increased. However, if the refrigerant flow path 18 is thinned, a flow rate of the refrigerant flowing in the refrigerant flow path 18 is increased, so that a pressure loss increases. Therefore, the refrigerant flow paths 18 are provided in the heat exchanger 13, and the refrigerant is distributed into each refrigerant flow path 18 by a distributor. With this arrangement, an amount of the refrigerant flowing in each refrigerant flow path 18 is reduced while increasing the heat exchange area by thinning the refrigerant flow path 18. The pressure loss is thereby reduced.

Herein, the description has been given, using the heat exchanger 13 as an example. The heat exchanger 15, however, has also basically the same configuration.

When the heat pump apparatus 10 is used as an air conditioner, for example, the compressor 12, the heat exchanger 13, the expansion mechanism 14, and the four-way valve 16 are held in an outdoor unit, and the heat exchanger 15 is held in an indoor unit.

When a heating operation is performed, the four-way valve 16 is set so that the refrigerant circulates in the order of the compressor 12, the heat exchanger 15, the expansion mechanism 14, and the heat exchanger 13. Then, the heat exchanger 15 operates as a radiator, and the heat exchanger 13 operates as an evaporator. The refrigerant that flows into the heat exchanger 13 which operates as the evaporator is in a gas-liquid two-phase state.

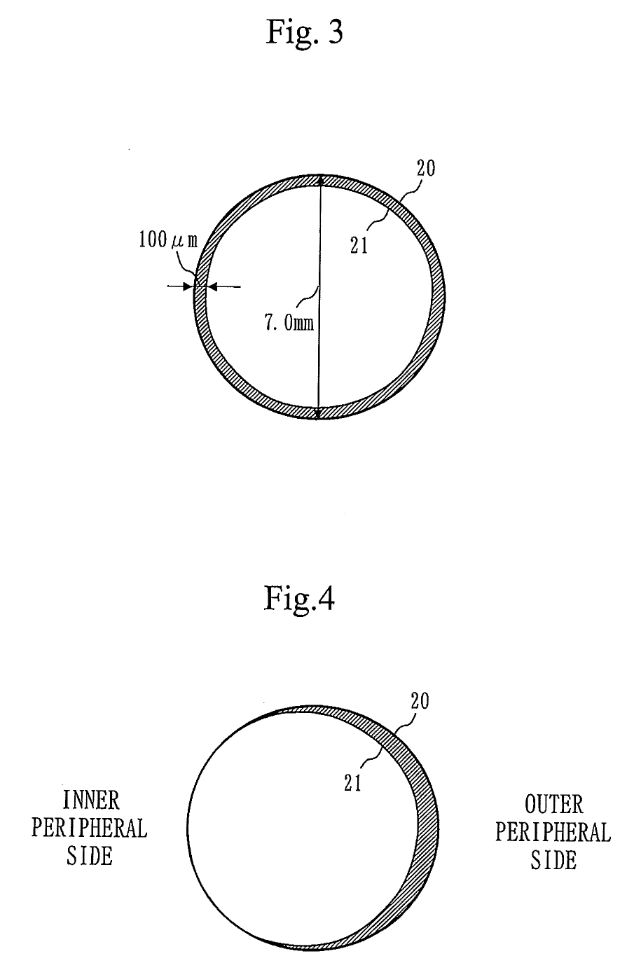

FIG. 3 is an explanatory diagram of the refrigerant flowing in a refrigerant pipe 20 on the entrance side of the evaporator.

The refrigerant pipe 20 in the air conditioner is often a smooth pipe with an inner diameter of about 7.0 mm. A total mass flow rate G[kg/h] of the refrigerant having a gas phase and a liquid phase is about 50 [kg/h]. Dryness X=G_{g}/(G_{g}+G_{L}) defined by a mass flow rate G_{g}[kg/h] of the refrigerant in the gas phase and a mass flow rate G_{L}[kg/h] of the refrigerant in the liquid phase is about 0.1. The refrigerant in the liquid phase has a density that is about 100 times as large as that of the refrigerant in the gas phase.

In this state, the refrigerant flows within the refrigerant pipe 20 as an annular flow. That is, the refrigerant in the liquid phase flows as a liquid film 21 along the inner wall of the refrigerant pipe, and the refrigerant in the gas phase flows inside the liquid film 21. The liquid film 21 has a thickness of about 100 [μm].

FIG. 4 is an explanatory diagram of the refrigerant flowing in a curved portion where the refrigerant pipe 20 has been bent.

The shape of the liquid film 21 in the refrigerant pipe 20 is determined by gravity, inertial force, and surface tension. Herein, the surface tension is a force that acts to reduce a surface area of the liquid film 21.

When the refrigerant pipe 20 is a smooth pipe, or a pipe with a smooth inner wall, and when the influence of the gravity and the inertial force is small, the liquid film 21 with a uniform thickness covers the inner wall as illustrated in FIG. 3. In the curved portion where the refrigerant pipe 20 has been bent, however, the liquid film 21 becomes biased to the outer peripheral side of the curve due to the inertial force, as illustrated in FIG. 4. The side of the curvature center of the curve is referred to as an inner peripheral side, while the side opposite to the curvature center of the curve is referred to as the outer peripheral side.

When the refrigerant pipe 20 is horizontally installed, the liquid film 21 becomes biased downward due to the influence of the gravity.

When the refrigerant flows into the distributor with the liquid film 21 biased, the refrigerant in the liquid phase is not uniformly distributed into each flow path. In the flow path in the heat exchanger 13 having a small distributed amount of the refrigerant in the liquid phase, the refrigerant is all turned into the gas phase. As a result, heat exchange efficiency of the heat exchanger 13 will remarkably deteriorate.

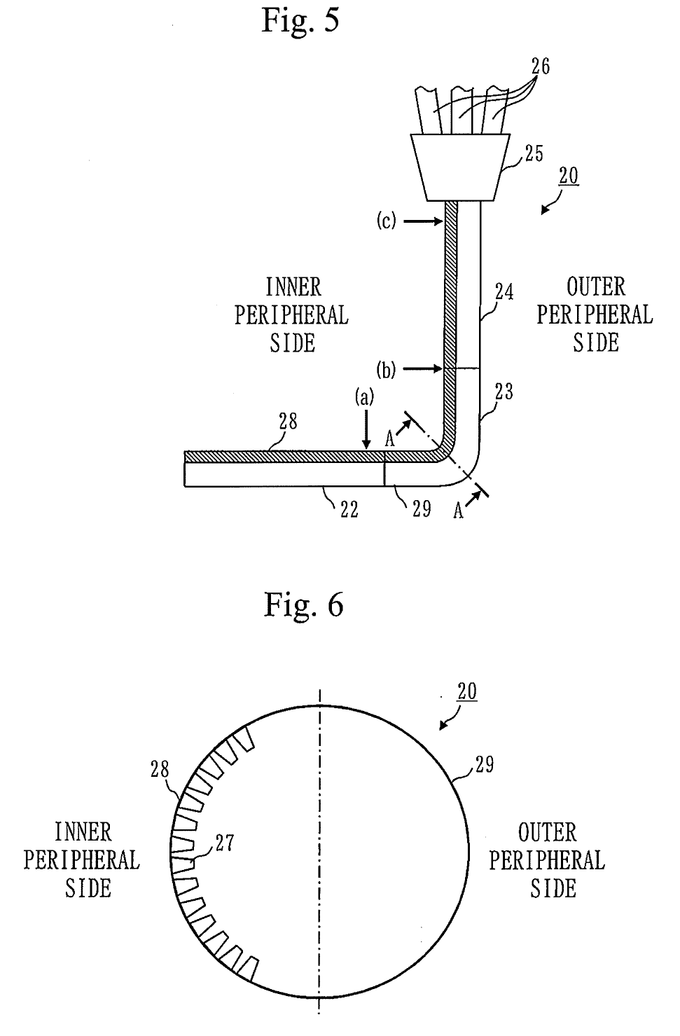

FIG. 5 is a diagram illustrating the refrigerant pipe 20 according to the first embodiment.

The refrigerant pipe 20 is a pipe in which the refrigerant flows, and is formed by sequential connection of an upstream pipe 22, a bent pipe 23, and a downstream pipe 24 from an upstream side. A distributor 25 to distribute the refrigerant into a plurality of refrigerant flow paths 26 is connected to the downstream side of the downstream pipe 24. The refrigerant sequentially passes through the upstream pipe 22, the bent pipe 23, and the downstream pipe 24, and is distributed into each refrigerant flow path 26 by the distributor 25.

The upstream pipe 22 and the downstream pipe 24 are each formed to be linear. The bent pipe 23 is formed to be bent in the shape of the curve.

FIG. 6 is a sectional view of the refrigerant pipe 20 according to the first embodiment.

FIG. 6 illustrates a section taken along A-A′ in FIG. 5. That is, FIG. 6 illustrates the section of the bent pipe 23. However, a section of each of the upstream pipe 22 and the downstream pipe 24 is also the same as the section of the bent pipe 23.

In each of the upstream pipe 22, the bent pipe 23, and the downstream pipe 24, the inner wall on the inner peripheral side of the bent pipe 23 being on the side of the curvature center of the curve is a grooved surface 28 where grooves 27 are formed, and the inner wall on the outer peripheral side of the bent pipe 23 being on the side opposite to the curvature center of the curve is a smooth surface 29. FIG. 5 illustrates the grooved surface 28 by hatching. The grooves 27 in the upstream pipe 22, the bent pipe 23, and the downstream pipe 24 are formed along the flowing direction of the refrigerant.

Specifically, the bent pipe 23 is formed to be bent in the shape of the curve. The inner wall on the inner peripheral side of the bent pipe 23 being on the side of the curvature center of the curve is the grooved surface 28 with the grooves 27 formed therein, and the inner wall on the outer peripheral side of the bent pipe 23 being on the side opposite to the curvature center of the curve is the smooth surface 29. The upstream pipe 22 is connected to the upstream side of the bent pipe 23 and is formed to be linear. The inner wall of the upstream pipe 22 that is the same side as the inner peripheral side of the bent pipe 23 is the grooved surface, and the inner wall of the upstream pipe 22 that is the same side as the outer peripheral side of the bent pipe 23 is the smooth surface. The downstream pipe 24 is connected to the downstream side of the bent pipe 23 and is formed to be linear. The inner wall of the downstream pipe 24 that is the same side as the inner peripheral side of the bent pipe 23 is the grooved surface, the inner wall of the downstream pipe 24 that is the same side as the outer peripheral side of the bent pipe 23 is the smooth surface. The distributor 25 to distribute the refrigerant into the plurality of flow paths is connected to the downstream side of the downstream pipe 24.

The grooved surface 28 has a larger surface tension than the smooth surface 29 because the grooves 27 are formed in the grooved surface 28. Therefore, unless the gravity and the inertial force are taken into consideration, the liquid film 21 becomes biased to the grooved surface 28.

***Description of Advantageous Effects***

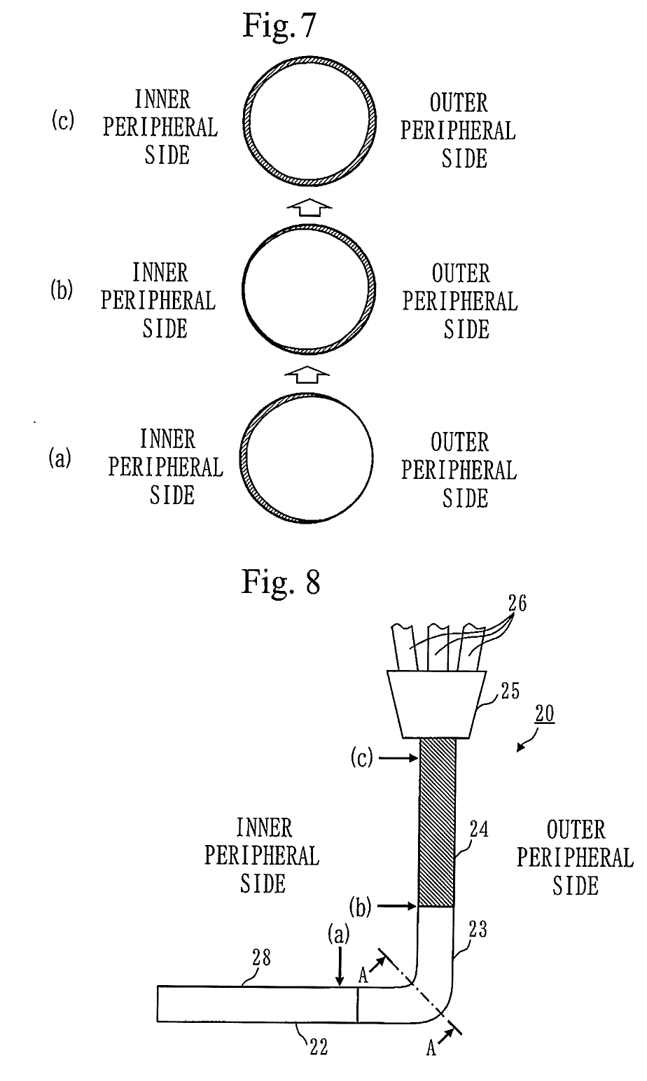

FIG. 7 includes diagrams illustrating states of the liquid film 21 in the refrigerant pipe 20 illustrated in FIG. 5. (a) to (c) of FIG. 7 respectively illustrate the states of the liquid film 21 in positions of (a) to (c) in FIG. 5.

For simplicity of description, it is assumed herein that there is no influence of the gravity. It is also assumed that, at a point of time when the refrigerant has flown into the upstream pipe 22, the liquid film 21 is not biased, and the liquid film 21 is uniformly flowing along the inner wall of the refrigerant pipe 20.

First, as illustrated in (a) of FIG. 7, the liquid film 21 that has flown in the upstream pipe 22 is drawn by the surface tension of the grooved surface 28 on the inner peripheral side of the upstream pipe 22. The liquid film 21 thereby becomes biased to the inner peripheral side.

Subsequently, as illustrated in (b) of FIG. 7, the liquid film 21 that has flown in the bent pipe 23 becomes biased to the outer peripheral side due to the inertial force caused by the flow in the bent portion. However, the biasing to the outer peripheral side is smaller than usual because, at a point of time when the liquid film 21 has flown into the bent pipe 23, the liquid film 21 has been biased to the inner peripheral side as illustrated in (a) of FIG. 7 and the liquid film 21 is drawn to the inner peripheral side due to the surface tension of the grooved surface 28 on the inner peripheral side of the bent pipe 23.

Then, as illustrated in (c) of FIG. 7, the liquid film 21 that has flown in the downstream pipe 24 is drawn by the surface tension of the grooved surface 28 on the inner peripheral side of the downstream pipe 24. The biasing to the outer peripheral side is eliminated, so that the liquid film 21 becomes uniform.

FIG. 8 is a diagram illustrating the refrigerant pipe 20 in which the entire inner wall of the downstream pipe 24 is set to the grooved surface 28, and the entire inner walls of the other pipes 22 and 23 are set to the smooth surface 29.

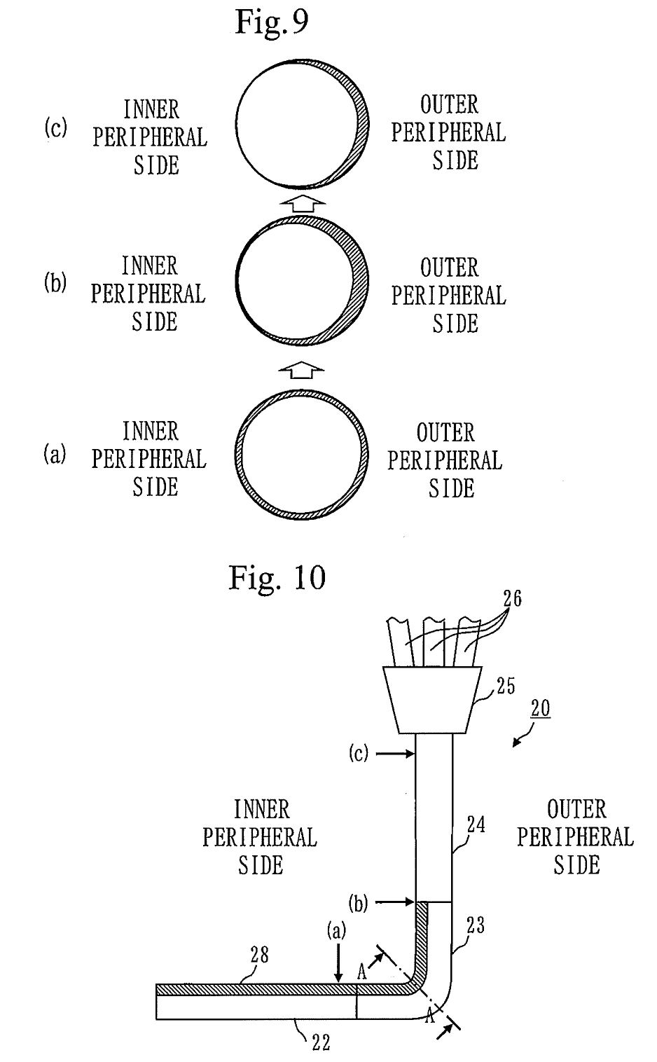

FIG. 9 includes diagrams illustrating states of the liquid film 21 in the refrigerant pipe 20 given in FIG. 8. (a) to (c) of FIG. 9 respectively illustrate the states of the liquid film 21 in positions of (a) to (c) in FIG. 8.

FIG. 9 includes the diagrams illustrated for comparison with FIG. 7. It is assumed, as in the case of FIG. 7, that there is no influence of the gravity. It is also assumed that, at a point of time when the refrigerant has flown into the upstream pipe 22, the liquid film 21 is not biased, and the liquid film 21 is uniformly flowing along the inner wall of the refrigerant pipe 20.

First, as illustrated in (a) of FIG. 9, the liquid film 21 that has flown in the upstream pipe 22 is uniform.

Subsequently, as illustrated in (b) of FIG. 9, the liquid film 21 that has flown in the bent pipe 23 becomes biased to the outer peripheral side due to the inertial force caused by the flow in the curved portion. In this case, the liquid film 21 becomes biased to the outer peripheral side more than the liquid film 21 that has flown in the bent pipe 23 in FIG. 7.

Then, as illustrated in (c) of FIG. 9, the liquid film 21 that has flown in the downstream pipe 24 approximates to be uniform because the entire inner wall is set to the grooved surface 28, but the liquid film 21 does not become uniform and remains being biased outward.

Assume that the entire inner wall of the downstream pipe 24 is set to the grooved surface 28. Then, unless the downstream pipe 24 is made long, the liquid film 21 cannot be made uniform at a point of time when the refrigerant flows into the distributor 25, as illustrated in FIG. 9.

On contrast therewith, in the refrigerant pipe 20 according to the first embodiment, it is so configured that the liquid film 21 becomes biased to the inner peripheral sides of the upstream pipe 22, the bent pipe 23, and the downstream pipe 24, as illustrated in FIG. 7. Therefore, even if the downstream pipe 24 is not made long, the liquid film 21 may be made uniform at a point of time when the refrigerant flows into the distributor 25.

As described above, in the refrigerant pipe 20 according to the first embodiment, the biasing of the liquid film 21 due to the inertial force is not modified after occurrence of the biasing. Before the biasing of the liquid film 21 occurs due to the inertial force, the surface tension is generated on the inner peripheral side to be balanced with a force toward the outer peripheral side caused by the inertial force. It is so configured that, with this arrangement, even if the downstream pipe 24 is not made long, the liquid film 21 may be made uniform at a point of time when the refrigerant flows into the distributor 25.

In the descriptions about FIG. 5 and FIG. 6, the inner walls on the inner peripheral sides of the upstream pipe 22, the bent pipe 23, and the downstream pipe 24 have been set to the grooved surface 28.

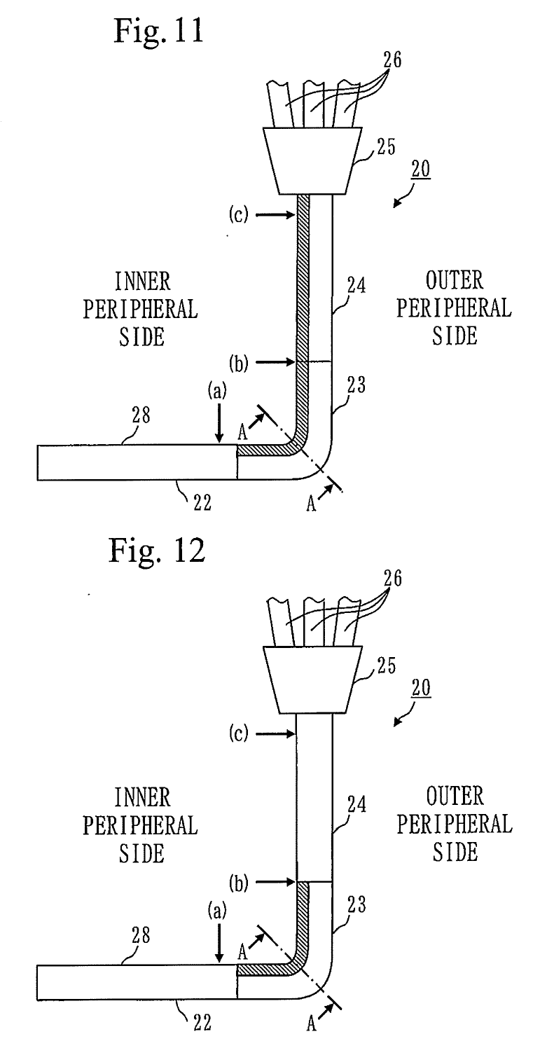

When the inertial force caused by bending of the bent pipe 23 is small, however, it may be so configured that the inner walls on the inner peripheral sides of the upstream pipe 22 and the bent pipe 23 are set to the grooved surface 28 and the inner wall on the inner peripheral side of the downstream pipe 24 is not set to the grooved surface 28, as illustrated in FIG. 10. Alternatively, it may be so configured that the inner walls on the inner peripheral sides of the bent pipe 23 and the downstream pipe 24 are set to the grooved surface 28 and the inner wall on the inner peripheral side of the upstream pipe 22 is not set to the grooved surface 28, as illustrated in FIG. 11. When the inertial force is further smaller, it may be so configured that the inner wall on the inner peripheral side of the bent pipe 23 is set to the grooved surface 28 and the inner walls on the inner peripheral sides of the upstream pipe 22 and the downstream pipe 24 are not set to the grooved surface 28, as illustrated in FIG. 12.

In other words, by changing a range of the grooved surface 28, the surface tension may be adjusted to be balanced with the inertial force.

In the descriptions about FIGS. 7 to 9, the descriptions have been given, assuming that there is no influence of the gravity.

However, actually, biasing of the liquid film 21 occurs due to the influence of the gravity. Then, it is necessary to determine whether or not the grooved surface 28 is to be provided in consideration of the gravity as well as the inertial force.

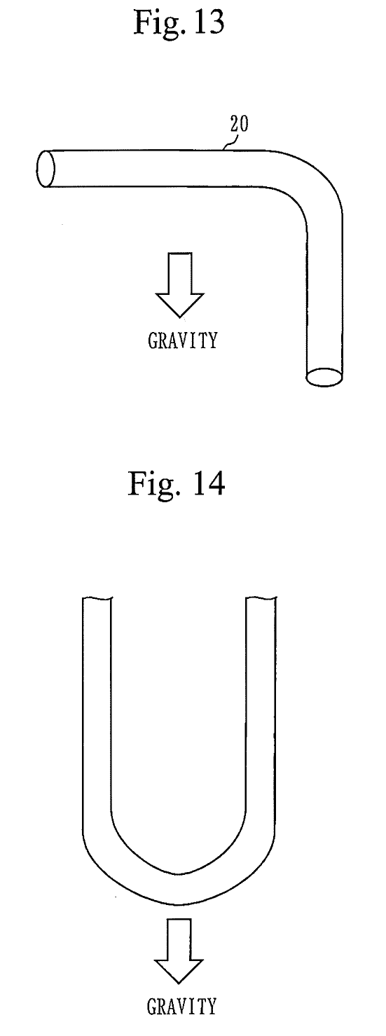

In the case of the refrigerant pipe 20 bent from a horizontal direction to a downward direction as illustrated in FIG. 13, for example, the gravity and the inertial force offset each other. Therefore, the range of the grooved surface 28 should be small so that the surface tension corresponding to the inertial force that cannot be offset by the gravity is generated. On the other hand, in the case of the refrigerant pipe 20 bent from a downward direction to an upward direction as illustrated in FIG. 14, both of the gravity and the inertial force become a force that will cause the liquid film 21 to become biased to the outer peripheral side. Therefore, it is necessary to set the range of the grooved surface 28 to be wide so that the surface tension corresponding to the force obtained by combining the gravity and the inertial force is generated.

In the descriptions about FIG. 5 and FIG. 6, it has been described that the inner wall on the outer peripheral side of the refrigerant pipe 20 is just set to the smooth surface 29. The smooth surface 29 may be processed to be water-repellent using a water-repellent coating such as a water-repellent fluorine coating after having been subject to fine uneven processing. This reduces a contact angle between the refrigerant and the inner wall on the outer peripheral side. As a result, the surface tension on the inner peripheral side may be relatively increased.

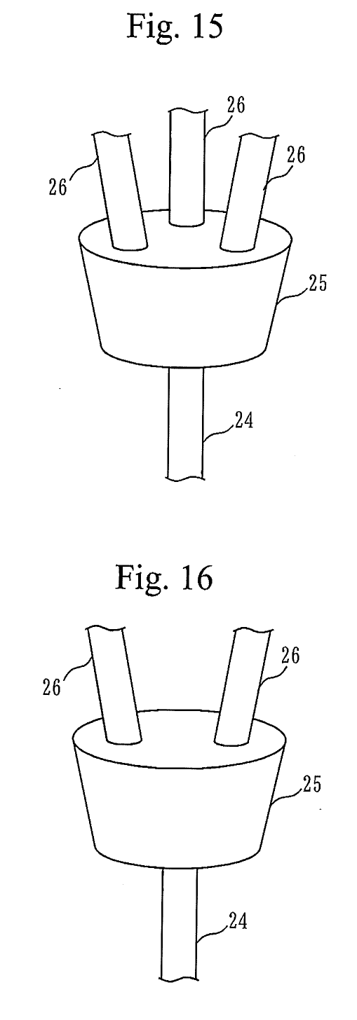

FIG. 15 is a diagram illustrating the distributor 25.

FIG. 15 illustrates the distributor 25 to distribute the refrigerant into three refrigerant flow paths 26. The respective refrigerant flow paths 26 are disposed on a circle centering around the center axis of the refrigerant pipe 20 at equal intervals, in the distributor 25. As described above, the refrigerant to be flown into the distributor 25 is the annular flow in which the liquid film 21 has become uniform. Thus, when the respective refrigerant flow paths 26 are disposed on the circle at the equal intervals, the refrigerant having the gas phase and the liquid phase is uniformly flown into the respective refrigerant flow paths 26.

When the refrigerant pipe 20 disposed immediately before the distributor 25 is inclined and the grooves 27 are provided in the lower inner wall of the refrigerant pipe 20 as described in Patent Literatures 1 and 2, the liquid film 21 becomes biased to the lower side of the refrigerant pipe 20. Consequently, when the refrigerant is distributed into two refrigerant flow paths 26 as illustrated in FIG. 16, the refrigerant may be uniformly distributed. However, it is difficult to uniformly distribute the refrigerant into three refrigerant flow paths 26 as illustrated in FIG. 15. It is also difficult to uniformly distribute the refrigerant into four or more refrigerant flow paths 26.

***Description of Manufacturing Method***

A description will be given about a method of manufacturing a pipe X with an inner wall on an inner peripheral side thereof set to the grooved surface 28 and an inner wall on an outer peripheral side thereof set to the smooth surface 29.

First, a pipe A1 with an entire inner wall set to the grooved surface 28 and a pipe B1 with an entire inner wall set to the smooth surface 29 are provided. Then, the pipe A1 is halved along a center line, thereby generating two pipes A2. Similarly, the pipe B1 is halved along a center line, thereby generating two pipes B2. Then, each pipe A2 and a corresponding one of the pipes B2 are combined using divided surfaces and are joined by welding or the like. With this arrangement, the pipe X with the inner wall on the inner peripheral side thereof set to the grooved surface 28 and with the inner wall on the outer peripheral side thereof set to the smooth surface 29 is manufactured.

Since each of the upstream pipe 22 and the downstream pipe 24 is a linear pipe, the pipe X manufactured can be used without alteration. On the other hand, the bent pipe 23 is a pipe bent in the shape of the curve. Thus, the bent pipe 23 is manufactured by performing bending on the pipe X manufactured so that the grooved surface 28 is on the inner peripheral side of the pipe X manufactured.

In a current technology, the grooves 27 may be provided in the inner wall of the refrigerant pipe 20 by rolling using a roll screw or a ball screw. When the refrigerant pipe 20 has an inner diameter of 7.0 mm in this case, minute grooves 27 each with a depth of 0.1 mm and a width of about 0.1 mm may be formed (see Non-Patent Literature 1).

The grooves 27 may also be formed by applying a pressure to the wall surface of the refrigerant pipe 20 to cause plastic deformation of the refrigerant pipe 20, using crushing from an outside.

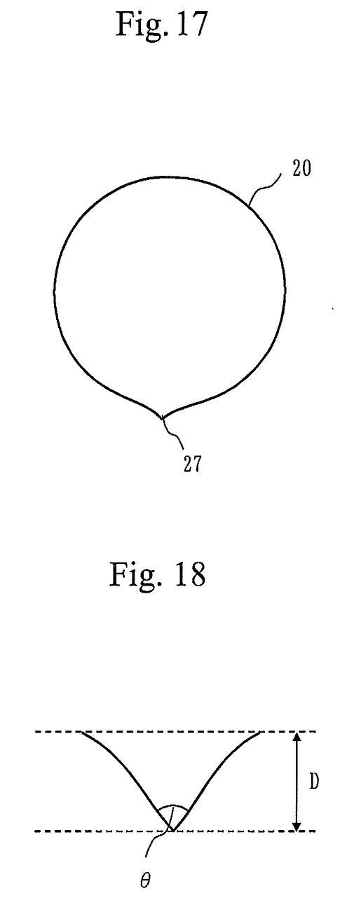

FIG. 17 is a diagram illustrating the refrigerant pipe 20 when the groove 27 has been formed by the crushing. FIG. 18 is an explanatory diagram of the groove 27 illustrated in FIG. 17.

In FIG. 17, one groove 27 is formed along the flow path of the refrigerant. When the groove 27 has been formed by the crushing, a depth D of the groove 27 increases more than in the case where the groove 27 has been formed by the rolling. The depth D of the groove 27 becomes about 1.0 mm.

The refrigerant in the liquid phase (liquid film 21) is drawn in each groove 27 by a capillary phenomenon caused by surface tension. A pressure of the refrigerant in the liquid phase drawn in each groove 27 is higher than a pressure of the refrigerant in the gas phase just by a Laplace pressure 2γ cos θ_{E}/h [Pa: Pascal]. Here, γ is a surface tension, θ_{E} is a contact angle between the refrigerant pipe 20 and the refrigerant. A surface tension F_{γ} per unit area is obtained by multiplying an area Dtan θ_{E} of the interface between the liquid phase and the gas phase by the Laplace pressure 2γ cos θ_{E}/h and is expressed as F_{γ}=(2γ cos θ_{E}/D)×D tan θ_{E} [N: newton].

Meanwhile, a gravity F_{g} [N] caused by the own weight of the refrigerant in the liquid phase is expressed as F_{g}=ρ gD² tan(θ/2) [N] because the volume of each groove 27 per unit length is D² tan(θ/2). Here, θ is an angle of the groove 27, ρ is a density of the refrigerant in the liquid phase, and g is a gravity acceleration.

It is assumed that the refrigerant pipe 20 has an internal diameter of 7.0 mm and that one groove 27 with the depth D of 1.0 mm and an angle of 70 degrees has been formed by crushing. When the refrigerant is assumed to be R410A, the density of the refrigerant in the liquid phase is 1061 [kg/m³], based on physical properties of R410A. Since the inner wall surface of the refrigerant pipe 20 is wet with the refrigerant, the contact angle θ_{E} between the inner wall surface and the refrigerant is small. It is assumed herein that the contact angle θ_{E} is 10 degrees. Then, the surface tension F_{γ} per unit area becomes F_{γ}=0.0070002 [N], and the gravity F_{g} caused by the own weight of the refrigerant in the liquid phase becomes F_{g}=0.006895 [N]. That is, the surface tension is roughly equivalent to the gravity.

Accordingly, when one groove 27 with the depth D of 1 mm and the angle of 70 degrees is formed by the crushing as illustrated in FIG. 17, the surface tension of a degree that offsets biasing to be caused by the gravity may be obtained. Then, it may be so arranged that the rolling and the crushing are used properly, according to the necessary surface tension. It may be so arranged, for example, that, in a part of the refrigerant pipe 20, the grooves 27 are formed by the rolling, and that in the remainder of the refrigerant pipe 20, the grooves 27 are formed by the crushing.

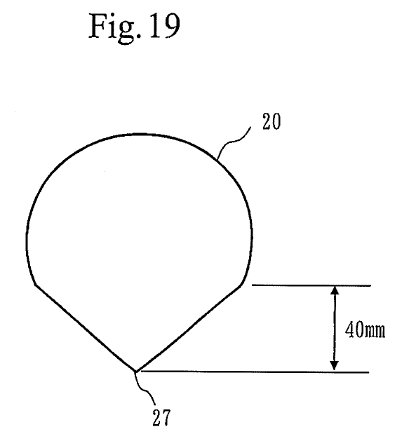

FIG. 19 is a diagram illustrating the refrigerant pipe 20 when the groove 27 has been formed by the crushing. In FIG. 17, the depth D of the groove 27 has been set to 1.0 mm. However, the groove 27 with a deeper depth may be formed by the crushing. Then, in FIG. 19, the depth D of the groove 27 is set to 4.0 mm.

The surface tension is determined by a distribution of the liquid film 21 and the angle of each groove 27. Therefore, the depth D of the groove 27 may be increased. By increasing the depth of the groove 27, an effect of the surface tension may be kept to be a certain level or more even if processing precision is low.

### REFERENCE SIGNS LIST

10: heat pump apparatus, 11: refrigerant circuit, 12: compressor, 13: heat exchanger, 14: expansion mechanism, 15: heat exchanger, 16: four-way valve, 17: fin, 18: refrigerant flow path, 19: dead region, 20: refrigerant pipe, 21: liquid film, 22: upstream pipe, 23: bent pipe, 24: downstream pipe, 25: distributor, 26: refrigerant flow path, 27: groove, 28: grooved surface, 29: smooth surface

1. A refrigerant pipe comprising:
a bent pipe formed to be bent in a shape of a curve and to flow a refrigerant, wherein an inner wall on an inner peripheral side of the bent pipe being on a side of a curvature center of the curve is a grooved surface with a groove formed therein, and an inner wall on an outer peripheral side of the bent pipe being on a side opposite to the curvature center of the curve is a smooth surface; and
a downstream pipe connected to a downstream side of the bent pipe, formed to be linear, and with a distributor connected thereto on the downstream side, the distributor being to distribute the refrigerant into a plurality of flow paths.

2. The refrigerant pipe according to claim 1,
wherein an inner wall of the downstream pipe on a same side as the inner peripheral side is the grooved surface, and an inner wall of the downstream pipe on a same side as the outer peripheral side is the smooth surface.

3. The refrigerant pipe according to claim 1, further comprising:
an upstream pipe connected on an upstream side of the bent pipe and formed to be linear, an inner wall of the upstream pipe on the same side as the inner peripheral side being the grooved surface and an inner wall of the upstream pipe on the same side as the outer peripheral side being the smooth surface.

4. The refrigerant pipe according to claim 1,
wherein the groove formed in the grooved surface of the bent pipe is formed along a flowing direction of the refrigerant.

5. The refrigerant pipe according to claim 1,
wherein a water repellant coating is applied to the smooth surface of the bent pipe.

6. The refrigerant pipe according to claim 1,
wherein the refrigerant in a gas-liquid two-phase state flows in the refrigerant pipe.

7. A heat pump apparatus comprising:
a refrigerant circuit where a compressor, a radiator, an expansion mechanism, and an evaporator are sequentially connected by a refrigerant pipe and a refrigerant circulates; and
a distributor provided on an entrance side of the evaporator in the refrigerant circuit to distribute the refrigerant into a plurality of flow paths;
wherein the refrigerant pipe connecting the expansion mechanism and the evaporator in the refrigerant circuit includes:
a bent pipe formed to be bent in a shape of a curve and to flow a refrigerant that has passed through the expansion mechanism, wherein an inner wall on an inner peripheral side of the bent pipe being on a side of a curvature center of the curve is a grooved surface with a groove formed therein and an inner wall on an outer peripheral side of the bent pipe being on a side opposite to the curvature center of the curve is a smooth surface; and
a downstream pipe connected to a downstream side of the bent pipe, formed to be linear, and with a distributor connected thereto on the downstream side.
